(19) United States
(12) Patent Application Publication
(10) Pub. No.: US 2019/0370418 A1
(43) Pub. Date: Dec. 5, 2019

(54) METHOD AND APPARATUS FOR ARRANGING WIND TURBINES BASED ON RAPID ACCESSMENT FLUID MODEL AND WAKE MODEL

(71) Applicant: BEIJING GOLDWIND SCIENCE & CREATION WINDPOWER EQUIPMENT CO., LTD., Beijing (CN)

(72) Inventors: Chuikuan ZENG, Beijing (CN); Wenhua SU, Beijing (CN)

(21) Appl. No.: 16/182,999

(22) Filed: Nov. 7, 2018

(30) Foreign Application Priority Data
May 29, 2018 (CN) 201810532210.3

(51) Int. Cl. G06F 17/50; F03D 13/30; F03D 80/00; G06N 3/12; G01P 5/02

(52) U.S. Cl. CPC G06F 17/5004; F03D 13/30; F03D 80/00; G06N 3/126; G01M 9/065; G01P 5/02; F05B 2270/20; G06F 2217/16; G06F 17/5009

(57) ABSTRACT

A method and an apparatus for arranging wind turbines based on a rapid assessment fluid model and a wake model. The method for arranging wind turbines includes: calculating, via a rapid assessment fluid model and based on an anemometry data of a predetermined area in a wind farm, a flow field data of the predetermined area in the wind farm; selecting a first wind-speed area from the predetermined area in the wind farm based on at least one of an occupied area limitation, a gradient limitation, a turbulence limitation or a wind speed limitation; and calculating, via a differential evolution algorithm, coordinates for arranging wind turbines that make annual power production of each wind turbine in the first wind-speed area highest. The annual power production of each wind turbine in the first wind-speed area is calculated based on the flow field data and the wake model.

The present disclosure claims the priority to Chinese Patent Application No. 201810532210.3, titled “METHOD AND APPARATUS FOR ARRANGING WIND TURBINES BASED ON RAPID ACCESSMENT FLUID MODEL AND WAKE MODEL”, filed on May 29, 2018 with the State Intellectual Property Office of People's Republic of China, the content of which is incorporated herein by reference.

### FIELD

The present disclosure relates to wind power generation technology, and in particular, to a method and an apparatus for arranging wind turbines based on a rapid assessment fluid model and a wake model.

### BACKGROUND

Wind power generation refers to converting kinetic energy of wind into electric energy. A wind turbine (also known as a wind power generating unit) is a device for wind power generation. In arrangement of the wind turbine, a wind speed corresponding to a location of the wind turbine is needed to calculate power production of the wind turbine, and coordinates for arranging wind turbines that facilitate improving the power production is selected based on the calculated power production.

In conventional technology, wind farm design software (such as Openwind and WindPro) is applied to arrange wind turbines. The conventional method for arranging wind turbines has a low computation speed and a calculation result with poor accuracy.

### SUMMARY

Aspects of the present disclosure address at least the above-mentioned issues, and further provide at least following advantages.

According to an aspect of the present disclosure, a method for arranging wind turbine based on a rapid assessment fluid model and a wake model is provided. The method for arranging wind turbines includes: calculating, via a rapid assessment fluid model and based on an anemometry data of a predetermined area in a wind farm, a flow field data of the predetermined area in the wind farm; selecting a first wind-speed area from the predetermined area in the wind farm, based on at least one of an occupied area limitation, a gradient limitation, a turbulence limitation or a wind speed limitation; calculating, via a differential evolution algorithm, coordinates for arranging wind turbines to acquire a scheme for arranging wind turbines, where the coordinates for arranging wind turbines make annual power production of each of multiple wind turbines in the first wind-speed area highest, the scheme for arranging wind turbines makes annual power production of the first wind-speed area highest; and arranging the plurality of wind turbines in the first wind-speed area based on the coordinates for arranging wind turbines; where the annual power production of each of the multiple wind turbines in the first wind-speed area is calculated based on the flow field data and the wake model.

Optionally, selecting the first wind-speed area from the predetermined area in the wind farm based on the occupied area limitation includes: excluding, from the predetermined area in the wind farm, at least one of a nature preservation area, a residential area or a preplanned non-occupied area to acquire the first wind-speed area.

Optionally, selecting the first wind-speed area from the predetermined area in the wind farm based on the gradient limitation includes: determining, based on a geographic information data of the predetermined area in the wind farm, grid points in the predetermined area in the wind farm; calculating, based on an elevation matrix, a gradient of each of the grid points in the predetermined area in the wind farm; and removing, from the predetermined area in the wind farm, a grid point having a gradient greater than a gradient threshold, to acquire the first wind-speed area.

Optionally, selecting the first wind-speed area from the predetermined area in the wind farm based on the turbulence limitation includes: determining, based on a geographic information data of the predetermined area in the wind farm, grid points in the predetermined area in the wind farm; determining, based on the calculated flow field data, a turbulence intensity of each of the grid points in the predetermined area in the wind farm; and removing, from the predetermined area in the wind farm, a grid point having a turbulence intensity greater than a turbulence threshold, to acquire the first wind-speed area.

Optionally, selecting the first wind-speed area from the predetermined area in the wind farm based on the wind speed limitation includes: determining, based on a geographic information data of the predetermined area in the wind farm, grid points in the predetermined area in the wind farm; determining, based on the calculated flow field data, an annual average wind speed of each of the grid points in the predetermined area in the wind farm; and removing, from the predetermined area in the wind farm, a grid point having an annual average wind speed smaller than a wind speed threshold, to acquire the first wind-speed area.

Optionally, calculating the annual power production of each of the multiple wind turbines in the first wind-speed area based on the flow field data and the wake model includes: setting wind speed regions with a quantity of n, where n is a natural number greater than 1; and calculating, based on a wind turbine power curve, the annual power production E of each of the multiple wind turbines in the first wind-speed area;

where

E=Σᵢ₌₁ⁿP(vᵢ)Tᵢ (1),

Vᵢ denotes a wind speed of an i-th wind speed region, P denotes the wind turbine power curve, Tᵢ denotes annual power generation hours of the i-th wind speed region, and the annual power generation hours Tᵢ is calculated based on

Tᵢ=[F(vᵢ+0.5)−F(vᵢ−0.5)]Tₜ (2),

where Tₜ denotes annual total hours, F(vᵢ+0.5) and F(vᵢ−0.5) are Weibull distribution functions, and in a case that it is determined via the wake model corresponding to the first wind-speed area that one of the multiple wind turbines is located in a wake area, a scale parameters in F(vᵢ+0.5) and F(vᵢ−0.5) is replaced with a value obtained from the scale parameter multiplied by a first annual average wind speed and then divided by a second annual average wind speed,

and where the first annual average wind speed is an annual average wind speed of the one of the multiple wind turbines located in the wake area calculated based on the wake model, and the second annual average wind speed is an annual average wind speed of the one of the multiple wind turbines located in the wake area calculated based on the rapid assessment fluid model.

Optionally, for each of the multiple wind turbines in the first wind-speed area, calculating via the differential evolution algorithm the coordinates for arranging wind turbines, where the coordinates for arranging wind turbines make the annual power production of each of the multiple wind turbines in the first wind-speed area highest, includes: performing mutation and crossover on a parent machine locating point to generate a subsidiary machine locating point, where the parent machine locating point is initially a machine locating point selected from the first wind-speed area; calculating annual power production corresponding to the parent machine locating point and annual power production corresponding to the subsidiary machine locating point, respectively; determining whether the annual power production corresponding to the subsidiary machine locating point is greater than the annual power production corresponding to the parent machine locating point; updating, in response to the annual power production corresponding to the subsidiary machine locating point being greater than the annual power production corresponding to the parent machine locating point, the parent machine locating point to be the subsidiary machine locating point; and maintaining the parent machine locating point unchanged in response to the annual power production corresponding to the subsidiary machine locating point not being greater than the annual power production corresponding to the parent machine locating point.

According to another aspect of the present disclosure, an apparatus for arranging wind turbines based on a rapid assessment fluid model and a wake model is provided. The apparatus for arranging wind turbines includes: a flow field simulation module, configured to calculate, via a rapid assessment fluid model and based on an anemometry data of a predetermined area in the wind farm, a flow field data of the predetermined area in the wind farm; a preprocess module, configured to select a first wind-speed area from the predetermined area in the wind farm based on at least one of an occupied area limitation, a gradient limitation, a turbulence limitation or a wind speed limitation; an optimization module, configured to calculate, via a differential evolution algorithm, coordinates for arranging wind turbines to acquire a scheme for arranging wind turbines, and arrange the plurality of wind turbines in the first wind-speed area based on the coordinates for arranging wind turbines; where the coordinates for arranging wind turbines make annual power production of each of multiple wind turbines in the first wind-speed area highest, the scheme for arranging wind turbines makes annual power production of the first wind-speed area highest, and the annual power production of each of the multiple wind turbines in the first wind-speed area is calculated based on the flow field data and the wake model.

Optionally, the preprocess module is configured to exclude, from the predetermined area in the wind farm, at least one of a nature preservation area, a residential area, or a preplanned non-occupied area to acquire the first wind-speed area.

Optionally, the preprocess module is configured to determine, based on a geographic information data of the predetermined area in the wind farm, grid points in the predetermined area in the wind farm, calculate, based on an elevation matrix, a gradient of each of the grid points in the predetermined area in the wind farm, and remove, from the predetermined area in the wind farm, a grid point having a gradient greater than a gradient threshold to acquire the first wind-speed area.

Optionally, the preprocess module is configured to determine, based on a geographic information data of the predetermined area in the wind farm, grid points in the predetermined area in the wind farm, determine, based on the calculated flow field data, a turbulence intensity of each of the grid points in the predetermined area in the wind farm, and remove, from the predetermined area in the wind farm, a grid point having a turbulence intensity greater than a turbulence threshold, to acquire the first wind-speed area.

Optionally, the preprocess module is configured to determine, based on a geographic information data of the predetermined area in the wind farm, grid points in the predetermined area in the wind farm, determine, based on the calculated flow field data, an annual average wind speed of each of the grid points in the predetermined area in the wind farm, and remove, from the predetermined area in the wind farm, a grid point having an annual average wind speed smaller than a wind speed threshold, to acquire the first wind-speed area.

Optionally, the optimization module is configured to calculate the annual power production of each of the multiple wind turbines in the first wind-speed area by: setting wind speed regions with a quantity of n, where n is a natural number greater than 1; and calculating, based on a wind turbine power curve, the annual power production E of each of the multiple wind turbines in the first wind-speed area;

where

E=Σᵢ₌₁ⁿP(vᵢ)Tᵢ (1),

Vᵢ denotes a wind speed of an i-th wind speed region, P denotes the wind turbine power curve, Tᵢ denotes annual power generation hours of the i-th wind speed region, and the annual power generation hours Tᵢ is calculated based on

Tᵢ=[F(vᵢ+0.5)−F(vᵢ−0.5)]Tₜ (2),

where Tₜ denotes annual total hours, F(vᵢ+0.5) and F(vᵢ−0.5) are Weibull distribution function, and in a case that it is determined via the wake model corresponding to the first wind-speed area that one of the multiple wind turbines is located in a wake area, a scale parameter in F(vᵢ+0.5) and F(vᵢ−0.5) is replaced with a value obtained from the scale parameter multiplied by a first annual average wind speed and then divided by a second annual average wind speed,

and where the first annual average wind speed is an annual average wind speed of the one of the multiple wind turbine located in the wake area calculated based on the wake model, and the second annual average wind speed is an annual average wind speed of the one of the multiple wind turbines located in the wake area calculated based on the rapid assessment fluid model.

Optionally, for each of the multiple wind turbines in the first wind-speed area, the optimization module is configured to calculate via the differential evolution algorithm the coordinates for arranging wind turbines, where the coordinates for arranging wind turbines make the annual power production of each of the multiple wind turbines in the first wind-speed area highest, by: performing mutation and crossover on a parent machine locating point to generate a subsidiary machine locating point, where the parent machine locating point is initially a machine locating point selected from the first wind-speed area; calculating annual power production corresponding to the parent machine locating point and annual power production corresponding to the subsidiary machine locating point, respectively; determining whether the annual power production corresponding to the subsidiary machine locating point is greater than the annual power production corresponding to the parent machine locating point; updating, in response to the annual power production corresponding to the subsidiary machine locating point being greater than the annual power production corresponding to the parent machine locating point, the parent machine locating point to be the subsidiary machine locating point; and maintaining the parent machine locating point unchanged in response to the annual power production corresponding to the subsidiary machine locating point not being greater than the annual power production corresponding to the parent machine locating point.

According to another aspect of the present disclosure, a computer readable storage medium is provided. The computer readable storage medium stores instructions, where the instructions when executed by a processor configure the processor to perform the aforementioned method for arranging wind turbines.

According to another aspect of the present disclosure, a computer device is provided. The computer device includes a processor and a computer readable storage medium, where the computer readable storage medium stores instructions, and the instructions when executed by the processor configure the processor to perform the aforementioned method for arranging wind turbines.

With the method and the apparatus for arranging wind turbines according to the present disclosure, the coordinates for arranging wind turbines which make the annual power production highest are calculated automatically, thereby achieving automation of calculation. The flow field data is calculated by utilizing the rapid assessment flow fluid model. The annual power production of each of the wind turbines in the first wind-speed area is calculated based on the flow field data and the wake model. The coordinates for arranging wind turbines which optimize the annual power production of each of the wind turbines in the first wind-speed area are calculated via the differential evolution algorithm. Thereby, speed of computation is improved.

The area not meeting requirements is excluded from the predetermined area in the wind farm based on at least one of the occupied area limitation, the gradient limitation, the turbulence limitation or the wind speed limitation, reducing calculation amount in the method for arranging wind turbines. The grid point having the annual average wind speed smaller than the wind speed threshold is removed, thereby preventing the problem of inaccurate calculation result caused by an annual average wind speed which is too small. The grid point having a gradient greater than the gradient threshold is removed, thereby preventing security risks resulted from installing a wind turbine at a location with a large gradient. The wake model is considered in calculation of the annual power production. Thereby, the annual power production is accurately calculated, and the optimal coordinates for arranging the wind turbines generates for arrangement are accurately calculated.

Part of other aspects and/or advantages of principles of the present disclosure are illustrated in the following description. The other part is clear from the description, or can be appreciated from implementing the principles of the present disclosure.

### BRIEF DESCRIPTION OF THE DRAWINGS

Detailed reference is made to embodiments of the present disclosure, and examples thereof are shown in the drawings. Same reference numbers refer to a same part. Hereinafter the embodiments are illustrated with reference to the drawings, so as to explain the present disclosure.

FIG. 1 is a flow chart of a method for arranging wind turbines based on a rapid assessment fluid model and a wake model according to an embodiment of the present disclosure;

FIG. 2 is a schematic diagram of an elevation matrix used in a process of selecting a first wind-speed area from a predetermined area in a wind farm according to an embodiment of the present disclosure; and

FIG. 3 is a block diagram of an apparatus for arranging wind turbines based on a rapid assessment fluid model and a wake model according to an embodiment of the present disclosure.

### DETAILED DESCRIPTION OF EMBODIMENTS

Hereinafter, embodiments of the present disclosure are described in detail in conjunction with the drawings.

Generally, multiple wind turbines are installed in a wind farm to realize wind power generation. Construction of the wind farm may include site selection (such as macroscopic site selection and microscopic site selection). During the site selection, installation position (also known as a machine locating point) of a wind turbine is determined. The installation position of the wind turbine may be represented by coordinates of the wind turbine.

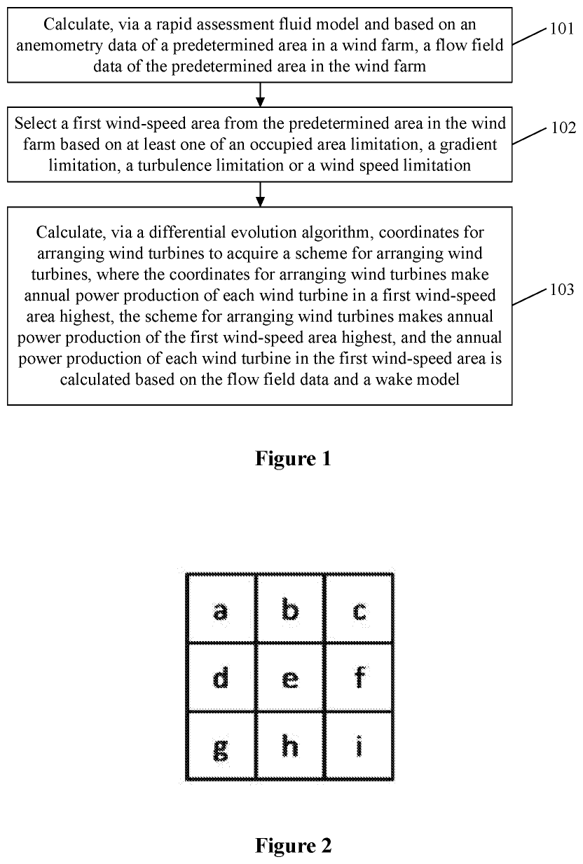

FIG. 1 is a flow chart of a method for arranging wind turbines based on a rapid assessment fluid model and a wake model according to an embodiment of the present disclosure. Optimal installation positions of wind turbines can be determined by the method for arranging wind turbines as shown in FIG. 1, that is, coordinates for arranging wind turbines which can make annual power production of each of wind turbines in a first wind-speed area highest. Herein the coordinates for arranging the wind turbines refers to coordinates for installing the wind turbines. In a case that the wind turbines are installed at such coordinates, the annual power production of each of the wind turbines in the first wind-speed area can be highest.

As shown in FIG. 1, a method for arranging wind turbines according to an embodiment of the present disclosure may include steps 101 to 103. In step 101, a flow field data of a predetermined area in a wind farm is calculated, via a rapid assessment fluid model and based on anemometry data of the predetermined area in the wind farm. In step 102, a first wind-speed area is selected from the predetermined area in the wind farm based on at least one of an occupied area limitation, a gradient limitation, a turbulence limitation or a wind speed limitation. In step 103, coordinates for arranging wind turbines are calculated via differential evolution (Differential Evolution, DE) algorithm to acquire a scheme for arranging wind turbines. The coordinates for arranging wind turbines make annual power production (Annual Energy Output, AEP) of each of multiple wind turbines in the first wind-speed area highest. The scheme for arranging wind turbines makes annual power production of the first wind-speed area highest. The annual power production of each of the multiple wind turbines in the first wind-speed area is calculated based on the flow field data and the wake model.

In an embodiment of the present disclosure, a geographic information data corresponding to the predetermined area in the wind farm may be acquired. The geographic information data includes coordinates in a three-dimensional coordinate system corresponding to the predetermined area in the wind farm. The predetermined area in the wind farm is divided based on the geographic information data, so as to acquire multiple grids. Ranges of a length and/or a width of each of the grids may be [100, 200] in a unit of meter, and the present disclosure is not limited thereto. A grid point may be selected from each of the grids, and the set grid point is represented by coordinates. The selected grid point may be a point located at an edge or a corner of the grid, and may be any point in the grid.

In an embodiment of the present disclosure, multiple anemometry points for installing an anemometer tower may be selected in advance in the predetermined area in the wind farm. Wind speed is measured at the multiple anemometry points with a predetermined time interval, so as to acquire the anemometry data.

In an embodiment of the present disclosure, the flow field data includes an annual average wind speed and/or a turbulence intensity. In a case that the multiple grid points is acquired by dividing the predetermined area in the wind farm based on the geographic information data, the annual average wind speed corresponding to any grid point in the predetermined area in the wind farm may be obtained through steps S111 to S113.

In step S111, an annual average wind speed value of each sector and a wind frequency corresponding to each sector, for each grid point, are acquired based on the anemometry data including wind speed data or mesoscale wind atlas data. The sector represents a wind direction. Specifically, an annual average wind speed Vₛᵥₑⁱ of an i-th sector may be calculated based on equation (5).

$${V}_{ave}^{i} = {a}_{i} Γ ( 1 + \frac{1}{{k}_{i}} ) \qquad ( 5 )$$

Γ denotes the gamma function, and aᵢ and kᵢ denote a scale parameter and a shape parameter, respectively, of the Weibull distribution function for the i-th sector at a current grid point. The wind frequency Fᵢ of the i-th sector at a current grid point may be calculated based on equation (6).

$${F}_{i} = \frac{{N}_{i}}{N} \qquad ( 6 )$$

Nᵢ denotes a quantity of the wind speed data of the i-th sector (a wind direction), and N denotes as a quantity of all anemometry data in all sectors (all wind directions). Generally, the wind frequency Fᵢ of the i-th sector can be directly read from the anemometry data, the mesoscale wind atlas data, or the like.

In step S112, a weight value of the annual average wind speed of each sector relative to an annual average wind speed of all sectors is calculated, for each grid point, based on the annual average wind speed of the sector and the wind frequency corresponding to the sector. Specifically, with the annual average wind speed Vₐᵥₑⁱ of the i-th sector and the wind frequency Fᵢ corresponding to the i-th sector, the weight value V_{sector}ⁱ of the annual average wind speed of the i-th sector relative to the annual average wind speed of all sectors is calculated based on equation (7).

V_{sector}ⁱ=Vₐᵥₑⁱ×Fᵢ (7)

In step S113, the annual average wind speed of each grid point is calculated based on the weight value of the annual average wind speed of each of the sectors relative to the annual average wind speed of all sectors. Specifically, the annual average wind V_{speed} of the current grid point (namely, an annual average wind speed of all sectors (all wind directions)) may be acquired based on the following equation (8), by adding weight values of the annual average wind speed of all sectors at the current grid point together.

V_{speed}=Σᵢ₌₁^{N}V_{sector}ⁱ (8)

N denotes a quantity of sectors.

In summary, the annual average wind speed at each grid point in the predetermined area in the wind farm can be finally calculated.

In an embodiment of the present disclosure, the annual average wind speed V_{speed} at each grid point in the predetermined area in the wind farm may be calculated through another method.

Specifically, the annual average wind speed V_{speed} at each grid point may be represented by equation (9).

V_{speed}=∫₀^{∞}vf(v)dv (9)

f is the Weibull distribution function of a whole year at the current grid point without considering the sectors. f(v) represents probability of wind speed v at the current grid point.

$$f ( V ) = \frac{k}{a} {( \frac{v}{a} )}^{k - 1} {e}^{- {( v / a )}^{k}} \qquad ( 10 )$$

a and k denote a scale parameter and a shape parameter of the Weibull distribution function of a whole year at the current grid point without considering the sectors. A following equation can be acquired based on the above equations (9) and (10).

$${V}_{speed} = a Γ ( 1 + \frac{1}{k} ) \qquad ( 11 )$$

Γ denotes the gamma function. Therefore, the annual average wind speed V_{speed} at each grid point can be calculated based on the above equation (11) according to the present disclosure.

Two methods for calculating the annual average wind speed V_{speed} at each grid point are described hereinabove, where the present disclosure is not limited thereto. The rapid assessment fluid model used for implementing the above manipulation on the flow field data is a model of Wind Atlas Analysis and Application Program (hereinafter referred to as WAsP).

In an embodiment of the present disclosure, for a reduced calculation amount and an accurate calculation result, at least one of following four manners may be applied to select the first wind-speed area from the predetermined area in the wind farm.

A first manner includes a following step. At least one of a nature preservation area, a residential area or a preplanned non-occupied area is excluded from the predetermined area in the wind farm to acquire the first wind-speed area.

A second manner includes the following steps. The grid points in the predetermined area in the wind farm are determined based on the geographic information data of the predetermined area in the wind farm. A gradient of each grid point in the predetermined area in the wind farm is calculated based on an elevation matrix. A grid point having a gradient greater than a gradient threshold (such as 15 degrees) is removed from the predetermined area in the wind farm, to acquire the first wind-speed area.

In an embodiment of the present disclosure, a grid system corresponding to the geographic information data is used. A length and a width of the grid are within a predetermined range (for example, a range of [10, 40] in a unit of meter).

FIG. 2 is a schematic diagram of an elevation matrix used in a process of selecting a first wind-speed area from a predetermined area in a wind farm according to an embodiment of the present disclosure.

As shown in FIG. 2, a, b, c, d, f, g, h and i are adjacent grids located around a central grid e. A gradient is determined by a changing rate (an increment) of a surface (which may be obtained from surface elevation information included in terrain data) in a horizontal direction (dz/dx) and a vertical direction (dz/dy) from the central grid e. The gradient is measured in a unit of degree. The gradient D of the central grid e is calculated based on equation (12).

D=atan(sqrt([dz/dx]²+[dz/dy]²))*57.29578 (12)

[dz/dx] denotes a changing rate at the central grid e in the x direction, and [dz/dy] denotes a changing rate of the central grid e in the y direction. [dz/dx] and [dz/dy] can be calculated based on equations (13) and (14).

[dz/dx]=((z_{c}+2z_{f}+zᵢ)−(zₐ+2z_{d}+z_{g})/(8*x_cellsize) (13)

[dz/dy]=((z_{g}+2zₕ+zᵢ)−(zₐ+2z_{b}+z_{c}))/(8*y_cellsize) (14)

zₐ, z_{b}, z_{c}, z_{d}, z_{f}, z_{g}, zₕ and zᵢ denote z-coordinates of grid a, b, c, d, f, g, h, and i, respectively. x_cellsize and y_cellsize denote sizes of a grid in the x direction and in the y direction, respectively.

In a case that z-coordinate of an adjacent grid of the central grid e is NoData (namely, does not have a data), z-coordinate of the central grid e is used as the z-coordinate of the adjacent grid. For example, at an edge of the grid system, there are at least three grids (namely, a grid located out of a range of the grid system) of which the z-coordinates are represented as NoData, and the z-coordinate of the central grid e are used as the z-coordinates of such grids. Coordinates (including x-coordinate, y-coordinate and z-coordinate) of the grids a, b, c, d, f, g, h and i may be represented by coordinates of a grid point corresponding to the grid.

A third manner includes following steps. The grid points in the predetermined area in the wind farm are determined based on the geographic information data of the predetermined area in the wind farm. A turbulence intensity of each grid point in the predetermined area in the wind farm is determined based on the calculated flow field data. A grid point having a turbulence intensity greater than a turbulence threshold is removed from the predetermined area in the wind farm, to acquire the first wind-speed area.

A fourth manner includes following steps. The grid points in the predetermined area in the wind farm are determined based on the geographic information data of the predetermined area in the wind farm. An annual average wind speed of each grid point in the predetermined area in the wind farm is determined based on the calculated flow field data. A grid point having the annual average wind speed smaller than a wind speed threshold (such as 4.5 meters per second) is removed from the predetermined area in the wind farm, to acquire the first wind-speed area.

The manners for selecting the first wind-speed area from the predetermined area in the wind farm are illustrative, and are not intended to limit the present disclosure. Other manners for selecting the first wind-speed area from the predetermined area in the wind farm may be used. For example, reselection according to a preset or random rule may be performed on the first wind-speed area obtained via the aforementioned manners.

In an embodiment of the present disclosure, that the annual power production of each wind turbine in the first wind-speed area is calculated based on the flow field data and the wake model includes steps 121 and 122.

In step 121, wind speed regions with a quantity of n are set, where n is a natural number greater than 1. For example, multiple wind speed regions with an interval of 1 m/s may be set. With a unit of meter per second, a first wind speed region has a wind speed range of [0, 1), a second wind speed region has a wind speed range of [1, 2), a third wind speed region has a wind speed range of [2, 3), and so forth.

In step 122, the annual power production E of each wind turbine in the first wind-speed area is calculated based on a wind turbine power curve and a following equation.

E=Σᵢ₌₁ⁿP(vᵢ)Tᵢ (1)

Vᵢ denotes a wind speed of the i-th wind speed region. P denotes the wind turbine power curve. Tᵢ denotes annual power generation hours of the i-th wind speed region, and may be calculated based on equation (2).

Tᵢ=[F(vᵢ+0.5)−F(vᵢ−0.5)]Tₜ (2)

F(vᵢ+0.5) and F(vᵢ−0.5) are the Weibull distribution functions, and are represented as follows.

F(vᵢ+0.5)=1−e^{-((v}^{ᵢ}^{+0.5)/a)}^{^{k}} (3)

F(vᵢ−0.5)=1−e^{-((v}^{ᵢ}^{-0.5)/a)}^{^{k}} (4)

a and k denote a scale parameter and a shape parameter, respectively, of the Weibull distribution function. In a case that it is determined via the wake model (such as a Park model) corresponding to the first wind-speed area that a wind turbine is located in a wake area, the parameter a in the above equations (3) and (4) are replaced with the following a*, and the annual power production of the wind turbine in the wake area is calculated by combining the equations (1) and (2).

$${a}^{*} = a \frac{{v}_{ave}^{*}}{{v}_{ave}} ,$$

V*ₐᵥₑ denotes an annual average wind speed of the wind turbine located in the wake area calculated based on the wake model. vₐᵥₑ denotes an annual average wind speed of the wind turbine located in the wake area calculated based on the rapid assessment fluid model.

Differential Evolution algorithm is a heuristic algorithm for calculating an optimum value of an objective function, and has an advantage of a high performance in convergence (such as high speed of convergence).

In an embodiment of the present disclosure, the step 103 may include performing the following operations on each of the multiple wind turbines in the first wind-speed area. Mutation and crossover are performed on a parent machine locating point to generate a subsidiary machine locating point, where the parent machine locating point is initially a machine locating point selected from the first wind-speed area. Annual power production corresponding to the parent machine locating point and annual power production corresponding to the subsidiary machine locating point are calculated respectively. It is determined whether the annual power production corresponding to the subsidiary machine locating point is greater than the annual power production corresponding to the parent machine locating point. The parent machine locating point is updated to be the subsidiary machine locating point in response to a positive determination. The parent machine locating point is maintained unchanged in response to a negative determination. The above steps are repeated for a predetermined times.

In an embodiment of the present disclosure, optimum coordinates for arranging wind turbines are calculated by steps 201 to 206.

In step 201, a quantity n of the wind turbines, an optional machine type WTGₖ, the geographic information data and the anemometry data are inputted, and the input data are initialized to acquire coordinates Lᵢ(0) of an initial parent machine locating point, where the coordinates is (x, y, z), 0<i≤n, and i is a natural number.

In step 202, it is determined, for each initial parent machine locating point, whether the inputted optional machine type WTGₖ is applicable based on IEC standards, and another machine type is selected in case of a negative determination. In a case that there is no applicable machine type, the method goes to step 201 for initialization again. In a case that an applicable machine is determined for each initial parent machine locating point, the initial parent machine locating point serves as a machine locating point of first generation. A machine type having higher power production is preferable in the step S202.

In step 203, a variation vector is calculated based on the following equation.

Uᵣᵢ(g+1)=Lᵣᵢ(g)+S(Lᵣⱼ(g)−Lᵣₖ(g)),

Uᵣᵢ(g+1) denotes the variation vector for generating a machine locating point of (g+1)-th generation. Lᵣᵢ(g), Lᵣⱼ(g) and Lᵣₖ(g) denote vector representations of three machine locating points of g-th generation, respectively. S denotes a scaling factor which represents a variation degree between subsidiary machine locating points and a parent machine locating point.

In step 204, candidate coordinates of the machine locating point of (g+1)-th generation are calculated based on the following equation.

$${V}_{i} ( g + 1 ) = \{ \begin{matrix}{U}_{i} ( g + 1 ) if rand \leq CK \\ {L}_{i} ( g )\end{matrix}$$

Vᵢ(g+1) denotes the candidate coordinates of the machine locating points of (g+1)th generation. Uᵢ(g+1) denotes coordinates corresponding to the variation vector Uᵣᵢ(g+1). rand is a random number. CK is a configurable parameter. Lᵢ(g) denotes coordinates of the machine locating point of g-th generation.

In step 205, it is determined whether the candidate coordinates Vᵢ(g+1) of the machine locating point of (g+1)-th generation is equal to the coordinates Lᵢ(g) of the machine locating point of g-th generation. In case of a positive determination, the coordinates Lᵢ(g) remain unchanged. In case of a negative determination, it is determined based on the IEC standards whether the optional machine type WTGₖ inputted at the coordinates Vᵢ(g+1) is applicable. In case of not being applicable, the method goes to the step 203. In case of being applicable, a machine type having highest power production is selected from the optional types, and annual power production E1 corresponding to the machine locating point at the coordinates Vᵢ(g+1) is calculated. It is assumed that annual power production corresponding to the machine locating point at the coordinates Lᵢ(g) is E2 (the annual power production of the wind turbines corresponding to the machine locating points of g-th generation is calculated in a previous phase of optimization). The coordinates Lᵢ(g) are replaced with Vᵢ(g+1) in a case that E1 is greater than E2, and the coordinates Lᵢ(g) remain unchanged in a case that E1 is smaller than or equal to E2.

In step 206, steps 203 to 205 are repeated for a predetermined times (such as 500 times).

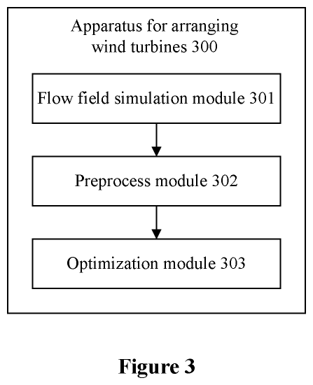

FIG. 3 is a block diagram of an apparatus for arranging wind turbines based on a rapid assessment fluid model and a wake model according to an embodiment of the present disclosure. As shown in FIG. 3, an apparatus 300 for arranging wind turbines based on a rapid assessment fluid model and a wake model, according to an embodiment of the present disclosure, includes a flow filed simulation module 301, a preprocess module 302, and an optimization module 303. The flow field simulation module 301 is configured to calculate, via a rapid assessment fluid model and based on an anemometry data of a predetermined area in the wind farm, flow field data of the predetermined area in the wind farm. The preprocess module 302 is configured to select a first wind-speed area from the predetermined area in the wind farm based on at least one of an occupied area limitation, a gradient limitation, a turbulence limitation or a wind speed limitation. The optimization module 303 is configured to calculate, via a differential evolution algorithm, coordinates for arranging wind turbines to acquire a scheme for arranging wind turbines, where the coordinates for arranging wind turbines make annual power production of each of multiple wind turbines in the first wind-speed area highest, the scheme for arranging wind turbines makes annual power production of the first wind-speed area highest. The optimization module 303 calculates the annual power production of each wind turbines in the first wind-speed area based on the flow field data and the wake model.

According to an embodiment of the present disclosure, the preprocess module 302 is configured to exclude, from the predetermined area in the wind farm, at least one of a nature preservation area, a residential area, or a preplanned non-occupied area to acquire the first wind-speed area.

According to an embodiment of the present disclosure, the preprocess module 302 is configured to determine, based on a geographic information data of the predetermined area in the wind farm, grid points in the predetermined area in the wind farm. The preprocess module 302 is configured to calculate, based on an elevation matrix, a gradient of each grid point in the predetermined area in the wind farm. The preprocess module 302 is configured to remove, from the predetermined area in the wind farm, a grid point having a gradient greater than a gradient threshold to acquire the first wind-speed area.

According to an embodiment of the present disclosure, the preprocess module 302 is configured to determine, based on a geographic information data of the predetermined area in the wind farm, grid points in the predetermined area in the wind farm. The preprocess module 302 is configured to determine, based on the calculated flow field data, a turbulence intensity of each grid point in the predetermined area in the wind farm. The preprocess module 302 is configured to remove, from the predetermined area in the wind farm, a grid point having a turbulence intensity greater than a turbulence threshold, to acquire the first wind-speed area.

According to an embodiment of the present disclosure, the preprocess module 302 is configured to determine, based on a geographic information data of the predetermined area in the wind farm, grid points in the predetermined area in the wind farm. The preprocess module 302 is configured to determine, based on the calculated flow field data, an annual average wind speed value of each grid point in the predetermined area in the wind farm. The preprocess module 302 is configured to remove, from the predetermined area in the wind farm, a grid point having the annual average wind speed smaller than a wind speed threshold, to acquire the first wind-speed area.

According to an embodiment of the present disclosure, the optimization module 303 is configured to calculate the annual power production of each of the multiple wind turbines in the first wind-speed area by following steps.

Wind speed regions with a quantity of n are set, where n is a natural number greater than 1.

The annual power production E of each wind turbine in the first wind-speed area is calculated based on a wind turbine power curve and a following equation.

E=Σᵢ₌₁ⁿP(vᵢ)Tᵢ (1)

Vᵢ denotes a wind speed of the i-th wind speed region. P denotes the wind turbine power curve. Tᵢ denotes annual power generation hours of the i-th wind speed region, and may be calculated based on equation (2).

Tᵢ=[F(vᵢ+0.5)−F(vᵢ−0.5)]Tₜ (2)

F(vᵢ+0.5) and F(v₁−0.5) are the Weibull distribution functions, and are represented as follows.

F(vᵢ+0.5)=1−e^{-((v}^{ᵢ}^{+0.5)/a)}^{^{k}} (3)

F(vᵢ−0.5)=1−e^{-((v}^{ᵢ}^{-0.5)/a)}^{^{k}} (4)

a and k denote a scale parameter and a shape parameter, respectively, of the Weibull distribution function. In a case that it is determined via the wake model (such as a Park model) corresponding to the first wind-speed area that a wind turbine is located in a wake area, the parameter a in the above equations (3) and (4) are replaced with the following a*, and the annual power production of the wind turbine in the wake area is calculated by combining the equations (1) and (2).

$${a}^{*} = a \frac{{v}_{ave}^{*}}{{v}_{ave}} ,$$

v*ₐᵥₑ denotes an annual average wind speed of the wind turbine located in the wake area calculated based on the wake model. vₐᵥₑ denotes an annual average wind speed of a wind turbine located in a wake area calculated based on a rapid assessment fluid model.

According to an embodiment of the present disclosure, for each of the multiple wind turbines in the first wind-speed area, the optimization module 303 is configured to calculate via the differential evolution algorithm the coordinates for arranging wind turbines, where the coordinates for arranging wind turbines make the annual power production of each wind turbine in the first wind-speed area highest, by following steps. Mutation and crossover are performed on a parent machine locating point to generate a subsidiary machine locating point, where the parent machine locating point is initially a machine locating point selected from the first wind-speed area. Annual power production corresponding to the parent machine locating point and annual power production corresponding to the subsidiary machine locating point are calculated respectively. It is determined whether the annual power production corresponding to the subsidiary machine locating point is greater than the annual power production corresponding to the parent machine locating point. The parent machine locating point is updated to be the subsidiary machine locating point in case of a positive determination. The parent machine locating point is maintained unchanged in case of a negative determination. The above steps are repeated for a predetermined times.

According to another embodiment of the present disclosure, a computer readable storage medium is provided. The computer readable storage medium stores instructions, where the instructions when executed by a processor configure the processor to perform the aforementioned method for arranging wind turbines.

According to another embodiment of the present disclosure, a computer device is provided. The computer device includes a processor and a computer readable storage medium. The computer readable storage medium stores instructions, and the instructions when executed by the processer configure the processor to perform the aforementioned method for arranging wind turbines.

The computer readable storage medium according to embodiments of the present disclosure includes program instructions, data files, data structure, etc., or a combination thereof. A program recorded in the computer readable storage medium may be programmed or configured to implement the method of the present disclosure. The computer readable storage medium further includes a hardware system for storing and executing the program instructions. The hardware system may be a magnetic medium (such as a hard disk, a floppy disk, and a magnetic tape), or an optical medium (such as a CD-ROM and a DVD), or a magneto-optical medium (such as a floppy optical disk, a ROM, a RAM, and a flash memory, etc.). The program includes assembly language codes or machine codes compiled by a compiler and higher-level language codes interpreted by an interpreter. The hardware system may be implemented with at least one software module to comply with the present disclosure.

One or more general purpose or dedicated computers (for example, processors, controllers, digital signal processors, microcomputers, field programmable arrays, programmable logic units, microprocessors, or any other devices capable of running software or executing instructions) may be utilized to implement at least a portion of the above method. The at least one portion may be implemented in an operating system or in one or more software applications operating under the operating system.

The description of the present disclosure is presented for purposes of illustration and description, and is not intended to exhaust or to limit the present disclosure in the disclosed form. For those skilled in the art, various modifications and changes may be made to the embodiments without departing from the concept of the present disclosure.

1. A method for arranging wind turbines, comprising:
calculating, via a rapid assessment fluid model and based on an anemometry data of a predetermined area in a wind farm, flow field data of the predetermined area in the wind farm;
selecting a first wind-speed area from the predetermined area in the wind farm based on at least one of: an occupied area limitation, a gradient limitation, a turbulence limitation or a wind speed limitation;
calculating, via a differential evolution algorithm, coordinates for arranging wind turbines to acquire a scheme for arranging wind turbines, wherein the coordinates for arranging wind turbines make annual power production of each of a plurality of wind turbines in the first wind-speed area highest, the scheme for arranging wind turbines makes annual power production of the first wind-speed area highest; and
arranging the plurality of wind turbines in the first wind-speed area based on the coordinates for arranging wind turbines;
wherein the annual power production of each of the plurality of wind turbines in the first wind-speed area is calculated based on the flow field data and a wake model.

2. The method for arranging wind turbines according to claim 1, wherein selecting the first wind-speed area from the predetermined area in the wind farm based on the gradient limitation comprises:
determining, based on a geographic information data of the predetermined area in the wind farm, grid points in the predetermined area in the wind farm;
calculating, based on an elevation matrix, a gradient of each of the grid points in the predetermined area in the wind farm; and
removing, from the predetermined area in the wind farm, a grid point having a gradient greater than a gradient threshold, to acquire the first wind-speed area.

3. The method for arranging wind turbines according to claim 1, wherein selecting the first wind-speed area from the predetermined area in the wind farm based on the turbulence limitation comprises:
determining, based on a geographic information data of the predetermined area in the wind farm, grid points in the predetermined area in the wind farm;
determining, based on the calculated flow field data, a turbulence intensity of each of the grid points in the predetermined area in the wind farm; and
removing, from the predetermined area in the wind farm, a grid point having a turbulence intensity greater than a turbulence threshold, to acquire the first wind-speed area.

4. The method for arranging wind turbines according to claim 1, wherein selecting the first wind-speed area from the predetermined area in the wind farm based on the wind speed limitation comprises:
determining, based on a geographic information data of the predetermined area in the wind farm, grid points in the predetermined area in the wind farm;
determining, based on the calculated flow field data, an annual average wind speed of each of the grid points in the predetermined area in the wind farm; and
removing, from the predetermined area in the wind farm, a grid point having an annual average wind speed smaller than a wind speed threshold, to acquire the first wind-speed area.

5. The method for arranging wind turbines according to claim 1, wherein calculating the annual power production of each of the plurality of wind turbines in the first wind-speed area based on the flow field data and the wake model comprises:
setting wind speed regions with a quantity of n, wherein n is a natural number greater than 1; and
calculating, based on a wind turbine power curve, the annual power production E of each of the plurality of wind turbines in the first wind-speed area;
wherein
E=Σᵢ₌₁ⁿP(vᵢ)Tᵢ,
Vᵢ denotes a wind speed of an i-th wind speed region, P denotes the wind turbine power curve, Tᵢ denotes annual power generation hours of the i-th wind speed region, and the annual power generation hours Tᵢ is calculated based on
Tᵢ=[F(vᵢ+0.5)−F(vᵢ−0.5)]Tₜ;
wherein Tₜ denotes annual total hours, F(vᵢ+0.5) and F(vᵢ−0.5) are Weibull distribution functions, and in a case that it is determined via the wake model corresponding to the first wind-speed area that one of the plurality of wind turbines is located in a wake area, a scale parameter in F(vᵢ+0.5) and F(vᵢ−0.5) is replaced with a value obtained from the scale parameter multiplied by a first annual average wind speed and then divided by a second annual average wind speed,
and wherein the first annual average wind speed is an annual average wind speed of the one of the plurality of wind turbines located in the wake area calculated based on the wake model, and the second annual average wind speed is an annual average wind speed of the one of the plurality of wind turbines located in the wake area calculated based on the rapid assessment fluid model.

6. The method for arranging wind turbines according to claim 1, wherein for each of the plurality of wind turbines in the first wind-speed area, calculating via the differential evolution algorithm the coordinates for arranging wind turbines, wherein the coordinates for arranging wind turbines make the annual power production of each of the plurality of wind turbines in the first wind-speed area highest, comprises:
performing mutation and crossover on a parent machine locating point to generate a subsidiary machine locating point, wherein the parent machine locating point is initially a machine locating point selected from the first wind-speed area;
calculating annual power production corresponding to the parent machine locating point and annual power production corresponding to the subsidiary machine locating point, respectively;
determining whether the annual power production corresponding to the subsidiary machine locating point is greater than the annual power production corresponding to the parent machine locating point;
updating, in response to the annual power production corresponding to the subsidiary machine locating point being greater than the annual power production corresponding to the parent machine locating point, the parent machine locating point to be the subsidiary machine locating point; and
maintaining the parent machine locating point unchanged in response to the annual power production corresponding to the subsidiary machine locating point not being greater than the annual power production corresponding to the parent machine locating point.

7. The method for arranging wind turbines according to claim 1, wherein selecting the first wind-speed area from the predetermined area in the wind farm based on the occupied area limitation comprises: excluding, from the predetermined area in the wind farm, at least one of a nature preservation area, a residential area, or a preplanned non-occupied area to acquire the first wind-speed area.

8. An apparatus for arranging wind turbines, comprising:
a flow field simulation module, configured to calculate, via a rapid assessment fluid model and based on an anemometry data of a predetermined area in the wind farm, a flow field data of the predetermined area in the wind farm;
a preprocess module, configured to select a first wind-speed area from the predetermined area in the wind farm based on at least one of: an occupied area limitation, a gradient limitation, a turbulence limitation or a wind speed limitation; and
an optimization module, configured to calculate, via a differential evolution algorithm, coordinates for arranging wind turbines to acquire a scheme for arranging wind turbines, and arrange the plurality of wind turbines in the first wind-speed area based on the coordinates for arranging wind turbines, wherein the coordinates for arranging wind turbines make annual power production of each of a plurality of wind turbines in the first wind-speed area highest, the scheme for arranging wind turbines makes annual power production of the first wind-speed area highest, and the annual power production of each of the plurality of wind turbines in the first wind-speed area is calculated based on the flow field data and a wake model.

9. The apparatus for arranging wind turbines according to claim 8, wherein the preprocess module is configured to:
determine, based on a geographic information data of the predetermined area in the wind farm, grid points in the predetermined area in the wind farm;
calculate, based on an elevation matrix, a gradient of each of the grid points in the predetermined area in the wind farm; and
remove, from the predetermined area in the wind farm, a grid point having the gradient greater than a gradient threshold, to acquire the first wind-speed area.

10. The apparatus for arranging wind turbines according to claim 8, wherein the preprocess module is configured to:
determine, based on a geographic information data of the predetermined area in the wind farm, grid points in the predetermined area in the wind farm;
determine, based on the calculated flow field data, a turbulence intensity of each of the grid points in the predetermined area in the wind farm; and
remove, from the predetermined area in the wind farm, a grid point having a turbulence intensity greater than a turbulence threshold, to acquire the first wind-speed area.

11. The apparatus for arranging wind turbines according to claim 8, wherein the preprocess module is configured to:
determine, based on a geographic information data of the predetermined area in the wind farm, grid points in the predetermined area in the wind farm;
determine, based on the calculated flow field data, an annual average wind speed of each of the grid points in the predetermined area in the wind farm; and
remove, from the predetermined area in the wind farm, a grid point having an annual average wind speed value smaller than a wind speed threshold, to acquire the first wind-speed area.

12. The apparatus for arranging wind turbines according to claim 8, wherein the optimization module is configured to calculate the annual power production of each of the plurality of wind turbines in the first wind-speed area by:
setting wind speed regions with a quantity of n, wherein n is a natural number greater than 1; and
calculating, based on a wind turbine power curve, the annual power production E of each of the plurality of wind turbines in the first wind-speed area;
wherein
E=Σᵢ₌₁ⁿP(vᵢ)Tᵢ,
Vᵢ denotes a wind speed of an i-th wind speed region, P denotes the wind turbine power curve, Tᵢ denotes annual power generation hours of the i-th wind speed region, and the annual power generation hours Tᵢ is calculated based on
Tᵢ=[F(vᵢ+0.5)−F(vᵢ−0.5)]Tₜ;
wherein F(vᵢ+0.5) and F(vᵢ−0.5) are Weibull distribution functions and are represented as
F(vᵢ+0.5)=1−e^{-((v}^{ᵢ}^{+0.5)/a)}^{^{k}} (3)
F(vᵢ−0.5)=1−e^{-((v}^{ᵢ}^{-0.5)/a)}^{^{k}} (4)
and a and k denote a scale parameter and a shape parameter, respectively, of the Weibull distribution functions,
wherein in a case that it is determined via the wake model corresponding to the first wind-speed area that one of the plurality of wind turbines is located in a wake area, the scale parameter in functions F(vᵢ+0.5) and F(vᵢ−0.5) is replaced with a value obtained from the scale parameter multiplied by a first annual average wind speed and then divided by a second annual average wind speed,
and wherein the first annual average wind speed is an annual average wind speed of the one of the plurality of wind turbines located in the wake area calculated based on the wake model, and the second annual average wind speed is an annual average wind speed of the one of the plurality of wind turbines located in the wake area calculated based on the rapid assessment fluid model.

13. The apparatus for arranging wind turbines according to claim 8, wherein for each of the plurality of wind turbines in the first wind-speed area, the optimization module is configured to calculate via the differential evolution algorithm the coordinates for arranging wind turbines, wherein the coordinates for arranging wind turbines make the annual power production of each of the plurality of wind turbines in the first wind-speed area highest, by:
performing mutation and crossover on a parent machine locating point to generate a subsidiary machine locating point, wherein the parent machine locating point is initially a machine locating point selected from the first wind-speed area;
calculating annual power production corresponding to the parent machine locating point and annual power production corresponding to the subsidiary machine locating point, respectively;
determining whether the annual power production corresponding to the subsidiary machine locating point is greater than the annual power production corresponding to the parent machine locating point;
updating, in response to the annual power production corresponding to the subsidiary machine locating point being greater than the annual power production corresponding to the parent machine locating point, the parent machine locating point to be the subsidiary machine locating point; and
maintaining the parent machine locating point unchanged in response to the annual power production corresponding to the subsidiary machine locating point not being greater than the annual power production corresponding to the parent machine locating point.

14. The apparatus for arranging wind turbines according to claim 8, wherein the preprocess module is configured to exclude, from the predetermined area in the wind farm, at least one of a nature preservation area, a residential area, or a preplanned non-occupied area to acquire the first wind-speed area.

15. A computer-readable storage medium, storing instructions, wherein the instructions when executed by a processor configure the processer to perform the method for arranging wind turbines according to claim 1.

16. A computer, comprising a processor and a computer-readable storage medium, wherein the computer-readable storage medium stores instructions, and the instructions when executed by the processor configure the processor to perform the method for arranging wind turbines according to claim 1.
